(19) United States
(12) Patent Application Publication
(10) Pub. No.: US 2009/0265583 A1
(43) Pub. Date: Oct. 22, 2009

(54) Monitoring Device Having Multiple Data Communication Paths

(75) Inventors: Kai T. Bouse, Tellico Plains, TN (US); Richard W. Piety, Knoxville, TN (US)

Correspondence Address: LUEDEKA, NEELY & GRAHAM, P.C., P O BOX 1871, KNOXVILLE, TN, 37901, US

(73) Assignee: CSI TECHNOLOGY, INC., Wilmington, DE (US)

(21) Appl. No.: 12/105,087

(22) Filed: Apr. 17, 2008

(51) Int. Cl. G06F 11/07

(52) U.S. Cl. 714/37; 714/E11.024

(57) ABSTRACT

A machine monitoring apparatus collects, processes and communicates machine data to be used for process control purposes and to be used in analyzing the machine performance. The apparatus includes one or more sensors that may be attached to or adjacent the machine for generating signals indicative of a performance parameter of the machine. An analog-to-digital converter converts the signals generated by the one or more sensors to bulk digital data corresponding to the sensed performance parameter. A processor receives and analyzes the bulk digital data and generates control digital data based on the bulk digital data. The control digital data may include one or more scalar values or status messages related to the operational performance of the machine as indicated by the bulk digital data. The apparatus includes a control data interface for providing access to the control digital data via a control data network, and a bulk data interface for providing access to the bulk digital data.

### FIELD

The present invention relates to data transfer devices and methods. More particularly, it relates to an apparatus and method for transferring data from a machine or process monitoring device over both a relatively low-bandwidth control data network and a relatively high-bandwidth bulk data network.

### BACKGROUND AND SUMMARY

In industrial process control environments, such as factories or industrial plants, various types of machinery are distributed about the industrial environment to maximize the efficiency of a process being performed by the machinery. In most processes it is necessary to measure environmental and process conditions such as temperature, pressure, flow rates, vibration and the like in order to ensure proper process characteristics and to determine whether process machines require preventive maintenance or repair. Additionally, in a process control system, control signals indicative of a measured condition are communicated over a control data network to and from various process control devices which are also referred to herein as field devices. Examples of control data networks include HART, FOUNDATION™ fieldbus and PROFIBUS™ networks.

Typically, a field device may measure one or more conditions, such as temperature, pressure or vibration, and generate one or more scalar values or status messages based on the measured conditions. These scalar values and/or status messages are typically communicated via a control data network which is part of a process control system that controls various machines and processes in the industrial environment. In some systems, machine fault values are generated at the field device and these values are communicated to a central processor via the control network. The central processor may use such information in an advisory fashion to make sometimes urgent decisions regarding machine shut-downs and alarms. Also, the central processor may communicate with a maintenance department in order to schedule preventative maintenance or repair activities.

In such an environment, machine maintenance personnel often do not have access to raw data, also referred to herein as bulk data, that a field device uses in generating machine fault values or status values. This may be because the fault condition was transitory in nature and the related data was lost, or because the amount of data is too large for transmission across a low-bandwidth control data network which is typically bandwidth restricted and suitable only for transfer of data such as scalar values and status alert messages. As a result, maintenance personnel often cannot determine the underlying problem with a machine due to lack of meaningful data.

Thus, there is a need for a field device that is capable of communicating control data over a control data network while also communicating raw or bulk data over a bulk data network.

The above and other needs are met by a machine monitoring apparatus for collecting, processing and communicating machine data. In a preferred embodiment, the apparatus comprises one or more sensors that may be attached to or adjacent the machine for generating signals indicative of a performance parameter of the machine. An analog-to-digital converter converts the signals generated by the one or more sensors to bulk digital data corresponding to the sensed performance parameter. A processor receives and analyzes the bulk digital data and generates control digital data based on the bulk digital data, where the control digital data comprises one or more scalar values or status messages related to the operational performance of the machine as indicated by the bulk digital data. The apparatus includes a first interface for providing access to the control digital data via a control data network, and a second interface for providing access to the bulk digital data. The first interface is also referred to herein as a control data network interface and the second interface is also referred to herein as a bulk data network interface.

In some embodiments, the first interface is compatible for communication with a control data network selected from the group consisting of a FOUNDATION™ fieldbus network, a PROFIBUS™ network and a Hart network. In some embodiments, the second interface is compatible to communicate the bulk digital data via a data link selected from the group consisting of an RS-422 link, an RS-485 link, an RS-232 link, an IEEE-1394 link, a Universal Serial Bus link, an Ethernet link, a Bluetooth wireless link and a IEEE 802.11 wireless link. In some embodiments, the second interface is compatible to communicate the bulk digital data to a removable data storage device selected from the group consisting of a portable magnetic hard disk drive, a flash memory device, an optical memory device, a CD drive and a DVD drive. In some embodiments, the second interface is compatible to communicate the bulk digital data to a portable computing device selected from the group consisting of a portable vibration data collector, a portable vibration data analyzer, a personal digital assistant (PDA) and a notebook computer.

In another aspect, the invention provides a method for assisting in the diagnosis of a machine fault by communicating data corresponding to a machine condition. In one embodiment, the method includes steps of:

(a) collecting bulk data indicative of an operational condition of a machine;
(b) analyzing the bulk data using a first processing device disposed adjacent the machine to generate one or more control data values or messages indicative of the operational condition of the machine;
(c) communicating the one or more control data values or messages over a control data network having a control data network bandwidth;
(d) making the bulk data available for communication over a bulk data network having a bulk data network bandwidth that is significantly greater than the control data network bandwidth;
(e) accessing the bulk data via the bulk data network using a second processing device in communication with the bulk data network; and
(f) processing the bulk data using the second processing device to determine details regarding the operational condition of the machine, wherein such details are not communicated by the one or more control data values or messages communicated in step (c). In preferred embodiments, the second processing device comprises a computer system or handheld data analyzer used by machine maintenance personnel to diagnose machine performance.

Further benefits and advantages of the present invention will become apparent after a careful reading of the detailed description with appropriate reference to the accompanying drawings.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a field device connected to a process control system and a bulk data system;

FIG. 2A depicts a first embodiment of the field device of FIG. 1;

FIG. 2B depicts a second embodiment of the field device of FIG. 1; and

FIG. 3 depicts a method for assisting in diagnosis of a machine fault by communicating bulk data corresponding to a machine condition.

### DETAILED DESCRIPTION

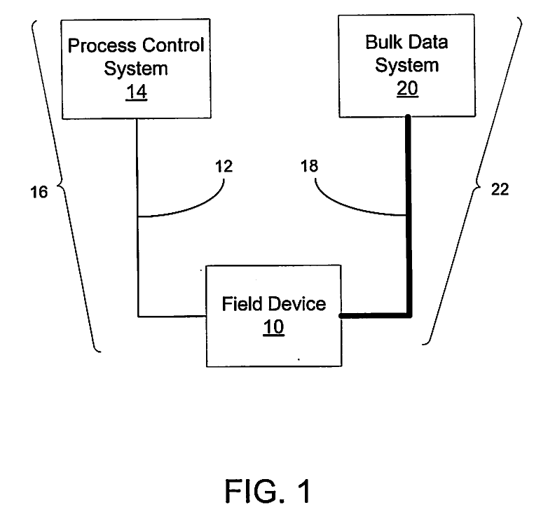

Referring to FIG. 1, a field device 10 is connected via a relatively low bandwidth communication pathway 12 to a process control system 14. The process control system 14 and the communication pathway 12 comprise a control data network 16. The control data network 16 typically is a relatively low bandwidth network suitable only for scalar values and status alert messages. Examples of control data networks include Hart, FOUNDATION™ fieldbus and PROFIBUS™ networks. The field device 10 is also connected via a relatively high bandwidth communication pathway 18 to a bulk data system 20. The bulk data system 20 and the communication pathway 18 comprise a bulk data network 22 which operates at a higher bandwidth than the control data network 16.

In various embodiments, the communication pathway 18 may be a serial data link such as an RS-422, RS-485, RS-232 or IEEE-1394 link, a USB link, an Ethernet link, or a wireless connection such as a Bluetooth or Wi-Fi link. In some embodiments, the bulk data system 20 is a locally-connected a portable computing device, such as a laptop computer, a portable vibration data collector and/or analyzer, or a personal digital assistant (PDA). In yet other embodiments, the bulk data system 20 is a removable storage device, such as a portable hard disk drive, a USB drive, SD memory card, mini-SD memory card, micro-SD memory card, Pro Duo memory card, a CD-ROM drive, a DVD-ROM drive, a flash memory device, or the like.

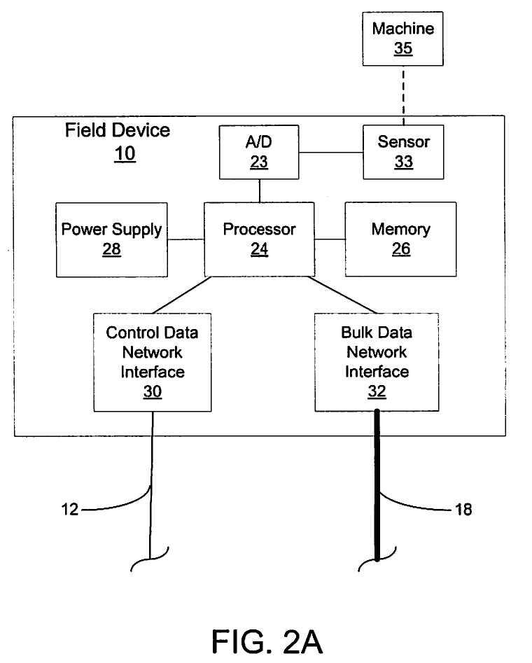

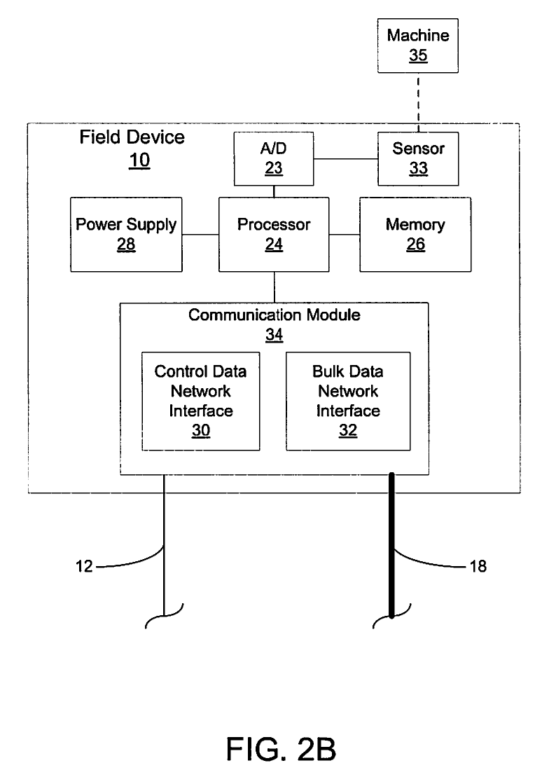

Referring now to FIG. 2A, the field device 10 includes a processor 24, memory 26, a power supply 28, a control data network interface 30, a bulk data network interface 32, an analog-to-digital (A/D) converter 23 and a sensor 33. The control data network interface 30 provides for communicating via the communication pathway 12 with the control data network 16, and the bulk data network communicator 32 provides for communicating via the communication pathway 18 with the bulk data network 22. The sensor 33 is typically attached to a machine 35 or other process component for sensing a machine parameter, such as vibration or temperature, and producing a machine signal representing the machine parameter. The machine signal is converted to digital data in the A/D 23 and is communicated to the processor 24 for analysis. In some embodiments, the machine data is stored in the memory 26 for later analysis. The processor 24 uses the machine data to generate control data that indicates a condition of the machine 35. As described above, the control data may include scalar values that indicate the status of the machine 35 or alert messages that may indicate a fault condition or the imminent onset of a fault condition. The machine data, which is also referred to herein as bulk data, typically includes all the raw data collected by the sensor 33.

FIG. 2B depicts an embodiment of the field device 10 wherein the processor is connected to a communication interface module 34 which includes the interfaces 30 and 32 connected to the communication pathway 12 and the communication pathway 18, respectively.

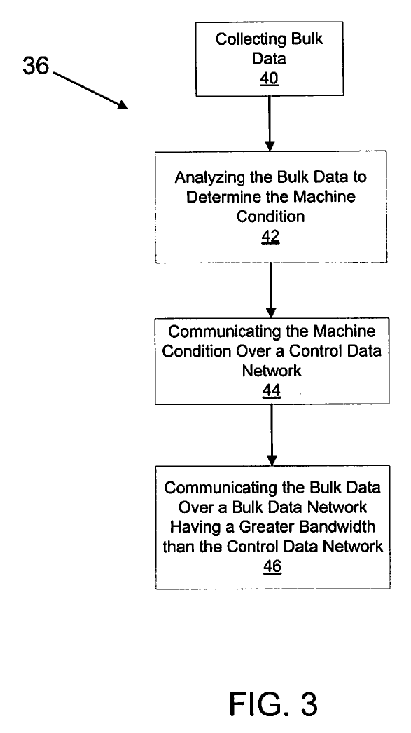

FIG. 3 depicts steps in a method 36 for assisting in diagnosis of a machine fault by communicating data corresponding to a machine condition. First, bulk data is collected which is indicative of a condition of a machine 35 (step 40). As described above, the bulk data may be generated at the output of the A/D 23. The processor 24 (FIG. 2) analyzes the bulk data to determine one or more machine condition values or to generate one or more status messages (step 42). The machine condition values and/or messages are communicated over the control data network 16 (step 44) and the bulk data is communicated over the bulk data network 22 (step 46) where it is made available for analysis by machine maintenance personnel.

Through the bulk data network, various embodiments of the invention provide maintenance personnel access to bulk data that is indicative of the condition of a machine. Without access to the bulk data, the maintenance personnel would have access only to the scalar data from the control network, which may indicate the general condition of a machine but does not necessarily represent why that condition exists. That is, significant bulk data is not typically available from a process control system due at least in part to bandwidth limitations of the control network. The field device 10 of FIGS. 1 and 2A-2B cures this problem by providing an interface to a dedicated, high-bandwidth communication pathway 18 for transfer of the bulk data for analysis by the maintenance personnel.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A machine monitoring apparatus for collecting, processing and communicating machine data, the apparatus comprising:
one or more sensors operable for attachment to or adjacent the machine for generating signals indicative of a performance parameter of the machine;
an analog-to-digital converter for converting the signals generated by the one or more sensors to bulk digital data corresponding to the sensed performance parameter;
a processor for receiving and analyzing the bulk digital data and generating control digital data based on the bulk digital data, the control digital data comprising one or more scalar values or status messages related to the operational performance of the machine as indicated by the bulk digital data;
a first interface for providing access to the control digital data via a control data network; and
a second interface for providing access to the bulk digital data.

2. The machine monitoring apparatus of claim 1 wherein the first interface is compatible for communication with a control data network selected from the group consisting of a FOUNDATION fieldbus network, a PROFIBUS network and a Hart network.

3. The machine monitoring apparatus of claim 1 wherein the second interface is compatible to communicate the bulk digital data via a data link selected from the group consisting of an RS-422 link, an RS-485 link, an RS-232 link, an IEEE-1394 link, a Universal Serial Bus link, an Ethernet link, a Bluetooth wireless link and a IEEE 802.11 wireless link.

4. The machine monitoring apparatus of claim 1 wherein the second interface is compatible to communicate the bulk digital data to a removable data storage device selected from the group consisting of a portable magnetic hard disk drive, a flash memory device, an optical memory device, a CD drive and a DVD drive.

5. The machine monitoring apparatus of claim 1 wherein the second interface is compatible to communicate the bulk digital data to a portable computing device selected from the group consisting of a portable vibration data collector, a portable vibration data analyzer, a personal digital assistant (PDA) and a notebook computer.

6. The apparatus of claim 1 further comprising a memory device connected to the processor for storing one or more of the control digital data and the bulk digital data.

7. The apparatus of claim 1 wherein the analog-to-digital converter, processor, first data interface and second data interface are dispose in a housing operable for attachment to or adjacent the machine.

8. A method for assisting diagnosis of a machine fault by communicating data corresponding to a machine condition, the method comprising:
(a) collecting bulk data indicative of an operational condition of a machine;
(b) analyzing the bulk data using a first processing device disposed adjacent the machine to generate one or more control data values or messages indicative of the operational condition of the machine;
(c) communicating the one or more control data values or messages over a control data network having a control data network bandwidth;
(d) making the bulk data available for communication over a bulk data network having a bulk data network bandwidth that is significantly greater than the control data network bandwidth;
(e) accessing the bulk data via the bulk data network using a second processing device in communication with the bulk data network; and
(f) processing the bulk data using the second processing device to determine details regarding the operational condition of the machine, wherein such details are not communicated by the one or more control data values or messages communicated in step (c).

9. The method of claim 8 wherein step (c) comprises communicating the one or more control data values or messages over a control data network selected from the group consisting of a FOUNDATION fieldbus network, a PROFIBUS network and a Hart network.

10. The method of claim 8 wherein step (d) comprises making the bulk data available for communication via a data link selected from the group consisting of an RS-422 link, an RS-485 link, an RS-232 link, an IEEE-1394 link, a Universal Serial Bus link, an Ethernet link, a Bluetooth wireless link and a IEEE 802.11 wireless link.

11. The method of claim 8 wherein step (d) comprises making the bulk data available for communication via a removable data storage device selected from the group consisting of a portable magnetic hard disk drive, a flash memory device, an optical memory device, a CD drive and a DVD drive.

12. The method of claim 8 wherein step (d) comprises making the bulk data available for communication to a portable computing device selected from the group consisting of a portable vibration data collector, a portable vibration data analyzer, a personal digital assistant (PDA) and a notebook computer.

13. A machine monitoring apparatus for collecting, processing and communicating machine performance data, the apparatus comprising:
means for collecting bulk data indicative of an operational condition of a machine;
means for analyzing the bulk data using a processing device disposed adjacent the machine to generate one or more control data values or messages indicative of the operational condition of the machine;
means for communicating the one or more control data values or messages over a control data network having a control data network bandwidth; and
means for making the bulk data available for communication over a bulk data network having a bulk data network bandwidth that is significantly greater than the control data network bandwidth.
